(19) United States
(12) Patent Application Publication
(10) Pub. No.: US 2005/0147872 A1
(43) Pub. Date: Jul. 7, 2005

(54) Pressure dissipation assembly for electrochemical cell

(76) Inventors: Gregory J. Davidson, Oregon, WI (US); Aaron J. Rositch, Oshkosh, WI (US); Viet H. Vu, Verona, WI (US)

Correspondence Address: QUARLES & BRADY LLP, 411 E. WISCONSIN AVENUE, SUITE 2040, MILWAUKEE, WI, 53202-4497, US

(21) Appl. No.: 10/988,726

(22) Filed: Nov. 15, 2004

Related U.S. Application Data
(60) Provisional application No. 60/519,669, filed on Nov. 13, 2003.

(51) Int. Cl. H01M 2/12

(52) U.S. Cl. 429/53; 429/61; 429/50

(57) ABSTRACT

An electrochemical cell is presented having a pressure dissipation assembly that reversibly ceases cell operation when the internal cell pressure reaches a predetermined threshold. If, once the pressure dissipation assembly is activated, the internal pressure continues to increase to a second threshold, a venting mechanism is activated to release pressurized cell contents from the cell.

### CROSS-REFERENCE TO RELATED APPLICATIONS

This application claims priority to U.S. Provisional Patent Application Ser. No. 60/519,669 filed Nov. 13, 2003, the disclosure of which is hereby incorporated by reference as if set forth in its entirety herein.

### STATEMENT REGARDING FEDERALLY SPONSORED RESEARCH OR DEVELOPMENT

Not Applicable

### BACKGROUND

The present invention relates generally to electrochemical cells, and in particular, relates to an assembly for dissipating pressurized cell contents during operation of a nickel-metal hydride cell.

Conventional secondary nickel-metal hydride cells include a cylindrical battery can having a closed end that encases an electrode group comprising a spirally wound sheet in which a positive electrode, a separator, and a negative electrode are stacked on one another together with an alkali electrolyte liquid. The negative electrode is arranged on the outermost of the electrode group, so that it is electrically contacted with the battery can. The open end of the can is closed by a positive terminal end cap that is insulated from the can. The positive electrode is electrically connected to the positive terminal end cap. NiMH cells of this type are well known to those having ordinary skill in the art.

Such cells typically include a seal that prevents the materials disposed within the cell from escaping at the interface between the endplate and the container. During normal use of the cell, the pressure within the cavity is sufficiently low, thereby presenting substantially no threat to the integrity of the cell structure. However, if the battery is misused, substantial pressure may build up within the cell. For example, if a user exposes the cell to extreme heat, significant pressure may accumulate within the cell. If no means exists to dissipate the pressure, the battery could fail in an unpredictable manner. To prevent this occurrence, vents can be installed in the cell that remain closed until the pressure exceeds a threshold limit, at which time the vent will open, thereby permitting the pressure to dissipate from the cell and into the ambient environment.

Several disadvantages are associated with conventional vents. For instance, conventional vents include large grommets and other components that occupy a significant amount of space within the cell that could otherwise be occupied by active anode/cathode materials. Additionally, conventional vents are designed to open at a pressure that is a function of the compression of a venting bore on a venting member. The amount of compression is not easily controlled during fabrication, and the operation of such vents has proven to be inconsistent and unpredictable.

What is therefore needed is a vent for an electrochemical cell that operates in a more predictable manner than conventionally achieved. It would be further desirable for the vent and switch to perform their respective functions while occupying a minimal amount of cell internal volume that is otherwise devoted to active electrochemical cell components.

### SUMMARY

In accordance with one aspect of the invention, a pressure dissipation system is configured for installation in an electrochemical cell. The pressure dissipation system includes a switch controlling electrical communication between a terminal end of the cell and a cell electrode, and a vent that provides a venting channel for pressurized electrochemical cell contents when a predetermined venting pressure acts against a venting member disposed in the vent.

In accordance with another aspect of the invention, a vent mechanism is configured for installation in an electrochemical cell. The vent mechanism includes 1) a housing defining a bore having a first zone defined by a first diameter and a stepped zone defined by a second diameter less than the first diameter, and 2) a venting member disposed in the bore that provides a venting channel through the eyelet when a predetermined pressure acts against the venting member.

In accordance with still another aspect of the invention, an electrochemical cell includes a cell terminal disposed proximal a cell terminal end, an electrode in electrical communication with the cell terminal, and a pressure dissipation system. The pressure dissipation system includes 1) a switch controlling electrical communication between a terminal end of the cell and a cell electrode, and 2) a venting member that provides a venting channel when a predetermined venting pressure acts against the venting member.

In accordance with yet another aspect of the invention, a method is provided for venting pressure in response to an increase in pressure of an electrochemical cell of the type including an electrode, a cell terminal, a switch removably connecting the electrode to the cell terminal, and a venting member enabling cell pressure to dissipate. The method includes (A) opening the switch to remove the electrical connection between the electrode and the cell terminal, (B) experiencing an increase in cell pressure to a venting pressure threshold, and thereafter (C) actuating the venting member to provide a passageway enabling the increased cell pressure to dissipate.

Other aspects and advantages will become apparent, and a fuller appreciation of specific adaptations, compositional variations, and physical attributes will be gained upon an examination of the following detailed description of the various embodiments, taken in conjunction with the appended claims.

### BRIEF DESCRIPTION OF THE DRAWINGS

Reference is hereby made to the following figures in which like reference numerals correspond to like elements throughout, and in which:

FIG. 1 is a schematic partial sectional side sectional view of a nickel metal hydride electrochemical cell operating during normal operating conditions, the cell including a positive terminal end and incorporating a pressure dissipation assembly;

FIG. 2 is a schematic side elevation view of the positive terminal end illustrated in FIG. 1 during operation when internal cell pressure has exceeded a first threshold;

FIG. 3 is a schematic side elevation view of the positive terminal end illustrated in FIG. 1 during operation when internal cell pressure has exceeded a second threshold;

FIG. 4 is a chart illustrating the relationship between the diameter of the small bore and the internal cell pressure necessary to actuate the venting member;

FIG. 5 is a perspective view illustrating the spring illustrated in FIGS. 1-3; and

FIG. 6 is a schematic sectional view of the positive terminal end of an alternative electrochemical cell incorporating a pressure dissipation assembly operating during normal conditions.

### DESCRIPTION

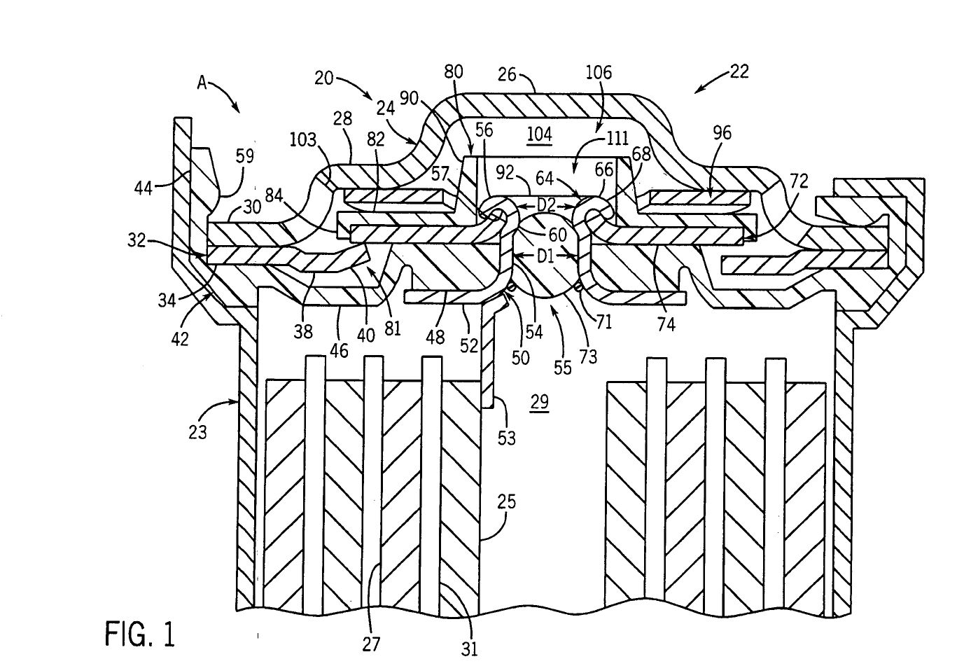

Referring now to FIG. 1, the positive terminal end 22 of an exemplary NiMH (nickel metal hydride) secondary electrochemical cell 20 is illustrated, though one skilled in the art will appreciate that the present invention can apply to other secondary cell types, for example rechargeable alkaline manganese, lithium ion, or any alternative cells as appreciated by one having ordinary skill in the art. The cell 20 is thus suitable for use in digital cameras, portable CD and DVD players, flashlights or other battery-powered devices, and comprises any size cylindrical cell, such as size AAAA, AAA, AA, C, Sub-C, and D size cells.

The cell 20 includes an outer conductive can 23 having closed end that defines the negative end of the cell, and an open end that defines the positive terminal end 22. The closed end of the can 23 is conventional and is not shown. A positive terminal end cap 24 is secured in the open end of the negative can 23 to provide closure to the cell. In particular, the cell 20 is closed by crimping the open (upper) end of the can 23 radially inwardly about Arrow A in FIG. 1, which illustrates the open end of the can 23 both before and after crimping.

A positive (e.g., nickel hydroxide) electrode 25 is in removable electrical connection with the positive terminal end cap 24, as will become more apparent from the description below. The cell further contains a negative electrode 27 (e.g., hydride electrode) that is in electrical connection with the can 23, and an alkaline electrolyte (e.g., potassium hydroxide) alone or in combination with other alkali metal hydroxides. The electrodes are disposed in an internal cavity 29, and are separated by a separator 31. The cell 20 can further comprise conventional positive and negative-wound electrodes in its interior, although the relative size of these electrodes can be adjusted to meet the physical and electrical specifications of the cell.

The terminal end cap 24 houses a pressure dissipation assembly 106 that includes a pressure-responsive switch 81 operable to open an electrical connection between the end cap 24 and the electrode when the internal cell pressure has reached a first threshold. The pressure dissipation assembly 106 further includes a vent 111 that enables the release of pressurized cell contents when the internal cell pressure has reached a second threshold.

The components disposed in the positive terminal end 22 generally include the end cap 24 that is held in contact with a first conductive washer 32 by a grommet 42. A second conductive washer 72 is in removable contact with the first conductive washer 32 under the forces provided by a spring member 96, which is separated from the second washer 72 by an insulating member 80. An eyelet 50 is connected to the second conductive washer 72 at one end, and is further electrically connected to the positive electrode 25. These components will now be described in detail.

Specifically, the positive terminal end cap 24 is an annular member including a central nubbin 26 that defines the positive cell terminal, a depressed annular horizontal step 28 that surrounds the nubbin 26, and a further depressed annular flange 30 that surrounds the step 28. The end cap 24 defines an internal void 104 disposed below the nubbin 26 and the step 28. A channel 103 extends through the end cap 24 at a location between the step 28 and the flange 30.

The first conductive washer 32 is also an annular member, and is disposed immediately beneath, and is in direct contact with, the flange 30. Specifically, the first washer 32 defines an upper plate 34 at its periphery whose upper surface is in contact with the flange 30, and a lower plate 38 that extends radially inwardly from the upper plate 34. The inner end of the lower plate 38 includes a plurality of upwardly bent fingers 40 (e.g., three fingers that are circumferentially spaced approximately 120° from each other).

The grommet 42 is an annular insulating member, and can be formed of any sufficiently flexible, nonconductive inert material that does not adversely impact the cell chemistry. Suitable materials include but are not limited to polypropylene polyolefin and nylon and their equivalents. The grommet 42 provides a seal against the can 23 to prevent unwanted leakage of anode or electrolyte from the cell during operation. The grommet 42 includes an annular hub 48 integrally connected to an outwardly extending flexible arm 46 which is, in turn, integrally connected to an outer end 44 that is disposed between the outer can and the radially outer edges of the flange 30 and the washer 32. The upper surface of the outer end of the arm 46 provides a seat for the washer 32. The outer end 44 insulates the end cap 24 and the washer 32 from the can 23. A lip 59 extends radially inwardly from the outer end 44 at a position above the flange 30. When the can 23 is crimped, the outer end 44 folds inwardly, which compresses the outer end 44 against the outer edges of the flange 30, and axially compresses the lip 59 against the flange 30.

The eyelet 50 includes an annular electrical conductor defining a stepped bore 55 extending axially therethrough. Specifically, the eyelet 50 includes a central cylindrical neck 54 extending along the radially inner end of the hub 48, the neck defining a first internal diameter D1. A fastening connector plate 52 is integrally connected to the lower end of the neck 54, and extends radially along the lower end of the hub 48. A flexible conductive tab 53 electrically connects the eyelet 50 to the positive electrode 25 in the interior 29 of the cell 20.

A hook-shaped wall 56 is integrally connected to the upper end of neck the 54, and includes a lower portion 60 that extends upwardly and radially inwardly from the neck 54. The lower portion 60 defines a tapered throat having a second inner diameter D2 at its narrowest point that is less than first diameter D1 of the neck 54. The stepped bore 55 is thus defined by first and second diameters D1 and D2. The wall 56 further includes an upper portion 64 that curves upwards and radially outwards from the throat 62 until reaching an upper end 66. An outer terminal portion 68 curves downwards and radially outwards from the upper portion 66. The wall 56 thus defines a radially outwardly-facing concave surface 57.

A compliant venting member 73 is disposed within the bore 55, and has an uncompressed outer diameter greater than the first diameter D1 of the bore 55. In one aspect, the venting member 73 has an uncompressed diameter within the range of 10% and 50% greater than the first diameter D1. The eyelet 50 can therefore also be referred to broadly as a housing that retains the venting member 73. The venting member 73 deforms so as to conform to the contour of the radially inner surface of the neck 54 and the lower portion 60 of the wall 56 when inserted into the bore 55. While the venting member 73 is a spheroid in accordance with one aspect of the invention, it should be appreciated that the venting member 73 could alternatively assume any suitable shape, such as an ovoid, capable of blocking fluid flow through the eyelet 50 until the internal cell pressure reaches a predetermined threshold, as will be described in more detail below.

While the stepped bore 55 is achieved via the eyelet 50 and the hook member 56 in accordance with one aspect of the invention, one skilled in the art will appreciate that the stepped bore can be achieved using any structure or combination of structures providing the electrical connections described herein that define an internal bore having a first diameter that is greater than a second diameter and being disposed downstream from the first diameter with respect to the direction of venting member travel during pressure dissipation, as will be described in more detail below. Furthermore, as illustrated, a retainer spring 71 can be installed at the interface between the venting member 73 and the eyelet 50 at a location beneath the venting member 73 to increase the compression of the venting member 73 against the stepped bore 55 and improving the seal that prevents active cell contents from leaking into the void 104 during normal operation.

The second conductive annular washer 72 includes a horizontally extending plate 74 that rides along the upper surface of the hub 48. The radially inner end of the plate 74 is bent upwards and extends into the concave surface 57 and in contact with the outer portion 68 of the eyelet 50. The lower surface of the outer end of the plate 74 is in removable contact with the fingers 40 of the first conductive washer 32. Accordingly, the conductive washers 32 and 72 provide contacts for a switch 81 responsive to internal cell pressure, as will be described in more detail below.

It should thus be appreciated that, during normal operation, the electrochemical circuit is completed by a path of electrical conductivity extending between the terminal end cap 24 and the electrode 25 via first and second conductive washers 32 and 72, respectively, the eyelet 50, and the tab 53, to enable the cell 20 to discharge and recharge.

The support member 80 is annular and can be formed from any insulating material, for example a plastic or rubber. The support member 80 includes a centrally disposed substantially cylindrical hub 90 that is positioned above the upper end 66 of the eyelet 50, and defines an internal bore 92 in radial alignment with the stepped bore 55. A horizontal arm 82 extends radially out from the lower end of the hub 90, and a flange 84 extends down from the radially outer end of the arm 82. The arm 82 extends along the upper surface of the plate 74, and is sized such that the flange 84 secures the radially outer end of the second conductive washer 72.

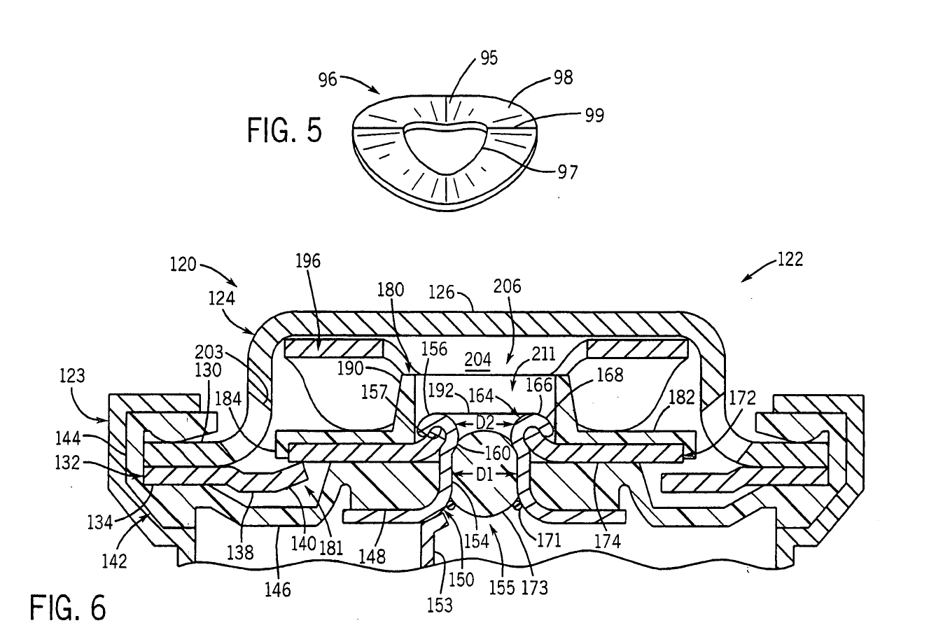

Referring also to FIG. 5, the spring member 96, which can be conductive or insulating, is monostable and includes an annular body 98 having a wavelike contour presenting opposing raised upper surfaces 99 and opposing depressed lower surfaces 95 spaced 90° radially from the upper surfaces 99. Because the annular body 98 does not lay flat against the step 28, and because a central aperture 97 extends through the body 98, the void 104 and the channel 103 are in fluid communication through the spring member 96. Alternatively, the spring member 96 can comprise a Bellville spring which, as well known in the art, is bi-stable.

Referring again to FIG. 1, during normal operation the conductive washers 32 and 72 are in contact, thus completing the electrochemical circuit between the nubbin 26 and the electrode 25. Furthermore, the venting member 73 is disposed in the eyelet 50, thereby preventing pressurized cell contents from traveling into the void 104.

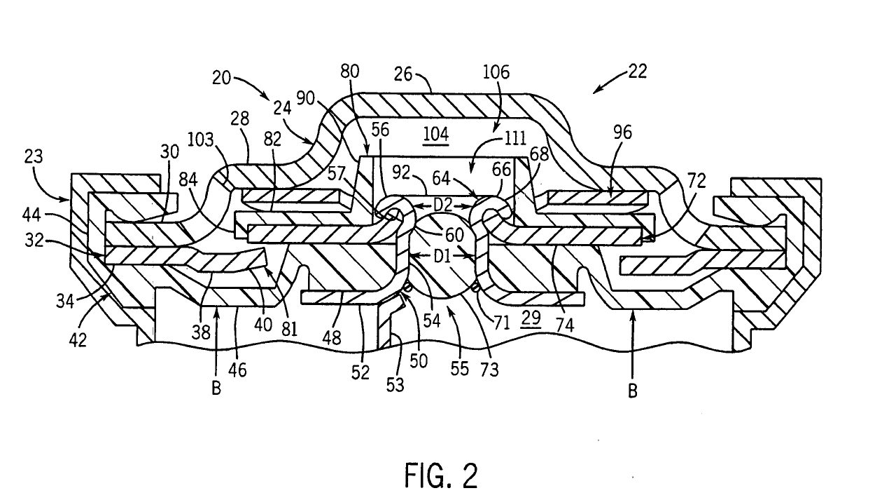

Referring now to FIG. 2, the present inventors have recognized that that internal pressure can accumulate in the cavity 29 when, for instance, a user exposes the cell to extreme heat or other abuse, or charges the cell at a rate that exceeds the cell's capability to receive the charge. Because the increasing cell pressure would eventually reach a decrimping pressure causing the cell can 23 to decrimp in an unpredictable manner, the pressure dissipation assembly 106 provides apparatus for the controlled depressurization of the cell 20.

Specifically, as internal pressure accumulates within the cavity 29, the pressure acts against the bottom surface of the grommet 42, and in particular the grommet arm 46, as indicated by Arrow B, and is offset by the downward force of the spring 96. Once the internal cell pressure reaches a predetermined switching threshold and overcomes the spring force, the arm 46 is raised downstream toward the nubbin 26, thereby causing the hub 48 to raise along with the eyelet 50 and the venting member 73. Because the horizontal portion 74 of the second conductive washer 72 rides along the upper surface of the hub 48, the second conductive washer 72 is also biased upwards against the force of the spring member 96. This movement removes the second conductive washer 72 from electrical contact with the fingers 40 of the first conductive washer 32, thus disrupting the electrochemical circuit described above.

The cell 20 therefore ceases to both charge and discharge when the grommet 42 is in the biased position illustrated in FIG. 2. The present inventors further recognize that the cause for the pressure increase may be only temporary. For instance, internal cell pressure can accumulate because the cell 20 is being charged at a rate that exceeds the charge capacity of the cell. By opening the contact between the conductive washers 72 and 32, the charge current is prevented from flowing through the cell, which will enable the cell pressure to dissipate to a level that is safe to continue charging if, for example, the increased cell pressure is caused from overcharging. It should be appreciated that the pressure also acts against the venting member 73, however the stepped bore 55 (and in particular diameter D2) prevents the venting member 73 from traveling through the eyelet and into the void 104.

If the pressure dissipates below a predetermined threshold, the spring 96 will overcome the upwards biasing force on the grommet 42 and bias the support member 80 downwardly, which will in turn bias the second conductive washer 72 downwardly into electrical contact with the bent sections 40. The grommet 42 is monostable, such that it will return to its original position illustrated in FIG. 1 when the internal cell pressure dissipates below the predetermined threshold. Because the stepped bore 55 renders the switching pressure insufficient to force the venting member 73 through the wall 56 due to the decreased size of diameter D2 with respect to throat diameter D1, the venting member 73 continues to prevent pressurized cell contents from flowing into the void 104. Furthermore, because the tab 53 flexes, the positive electrode 25 remains electrically connected to the eyelet 50 after the grommet 42 flexes in response to the switching pressure. Accordingly, the switch 81 advantageously provides a reversible and non-catastrophic system for discontinuing cell operation in response to elevated cell pressure.

The internal pressure required to open and close the switch 81 (i.e., switching threshold) can be determined based on several factors, including the flexibility of the grommet arm 46 and the biasing force of the spring 96. In accordance with certain aspects of the present invention, the switch 81 is configured to open when the internal cell pressure reaches a first elevated internal cell pressure threshold within the range defined at its lower end by 344 kPa or, alternatively 688 kPa, 1.03 mPa, or 1.55 mPa, and at its upper end by 1.9 mPa, or alternatively 2.76 mPa, or 4.14 mPa. In accordance with other aspects of the invention, the switching pressure is within a range defined at its lower end by 2%, and defined at its upper end by 40% with respect to the pressure required to decrimp the can 23.

Alternatively, if the spring 96 is a Bellville spring, the switching pressure would cause the spring 96 to irreversibly deflect when the switch 81 is opened. Because the spring 96 would not bias the second conductive washer 72 back into contact with the first conductive washer 32 after the switching pressure dissipates, the switch 81 would be rendered irreversibly open.

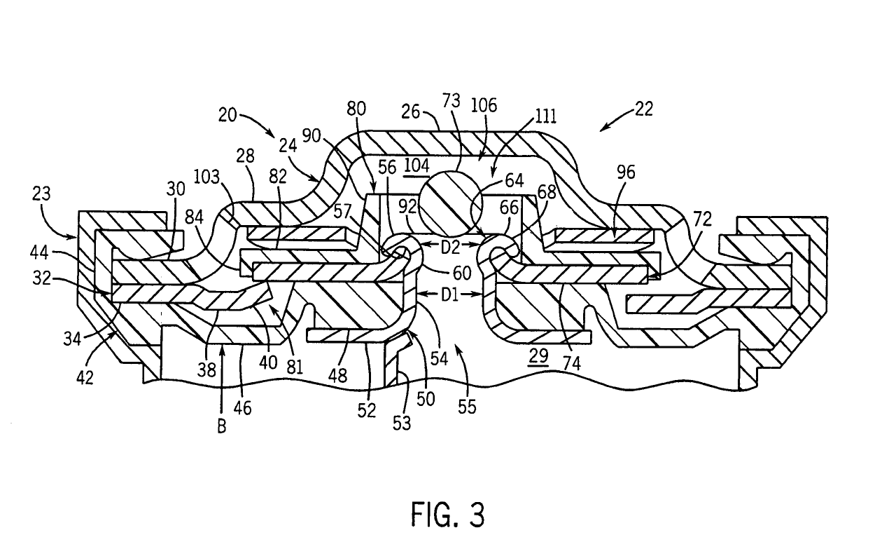

Referring now to FIG. 3, the present inventors recognize that the internal cell pressure increase might not be the result of fast charging, but instead might be caused by misuse of the cell 20. In such instances, if the misuse discontinues, the internal cell pressure will dissipate and the cell 20 can resume normal operation as the switch 81 is reversible and the pressurized cell contents do not vent from the cell 20 when the switch 81 is open. However, if the misuse continues, the increasing cell pressure could cause the cell 20 to decrimp in an unpredictable and explosive manner. Accordingly, if the pressure reaches a second venting threshold (less than the decrimping pressure), the pressure acting against the venting member 73 biases the venting member 73 through the throat 54 and the reduced diameter D2 of the lower hook portion 60 until the venting member 73 is displaced into the void 104 and clear of the stepped bore 55.

Once the venting member 73 is displaced, the stepped bore 55 provides a conduit through the eyelet 50 that places the internal cavity 29 and the end cap void 104 in fluid communication. As a result, pressurized gas and electrolyte flow from the internal cavity 29 into the void 104. The pressurized cell contents then travel from the void 104, through the gap formed between the spring 96 and the step 28 (or alternatively through the aperture extending through the Bellville spring 96), and exit the cell 20 through the outlet 103. Advantageously, because the venting pressure can be set at a level lower than the pressure required to decrimp the outer can, the internal cell pressure is dissipated in a predictable, and non-catastrophic manner.

Although internal cell pressure may dissipate when venting to a level less than the switching threshold (thus allowing the switch 81 to close), it should be appreciated that the venting of electrolyte and other cell contents prevents the cell from providing useful discharge or receiving a useful charge.

As noted above, the venting threshold is greater than the switching threshold and less than the decrimping pressure. Advantageously, the stepped bore 55 ensures that cell venting will not occur at the lower switching threshold, but rather that the cell will vent only upon the internal cell pressure reaching the venting threshold.

The internal pressure required to displace the venting member 73 into the void 104 (i.e., venting threshold) can be controlled by a number of factors, for instance the hardness and material of the venting member 73 and reduced diameter D2 relative to the diameter of the venting member 73 prior to compression. In accordance with certain aspects of the invention, the venting member 73 has a hardness within a range defined at its lower end by 35 IRHD (International Rubber Hardness Degrees) or, alternatively, 40 IRHD, and defined at its upper end by 80 IRHD or, alternatively, 90 IRHD. The force required to activate the venting member 73 is selected to maintain a safety margin between the vent pressure and the point at which the can decrimps. In accordance with certain aspects of the invention, the venting threshold is within a range defined at its lower end by 688 kPa or, alternatively 4.14 mPa, and at its upper end by 6.89 mPa or, alternatively, 13.79 mPa. In accordance with other aspects of the invention, the venting pressure is within a range defined at its lower end by 3%, and defined at its upper end by 85% with respect to the internal cell pressure required to decrimp the can 23. In accordance with other aspects of the invention, the venting pressure is at least 344 kPa greater with respect to the pressure necessary to open the switch and at least 344 kPa less with respect to the pressure at which the can decrimps. In another aspect of the invention, the can decrimps when the internal cell pressure is in a range defined at its lower end by 2.75 mPa and at its upper end by 17.93 mPa.

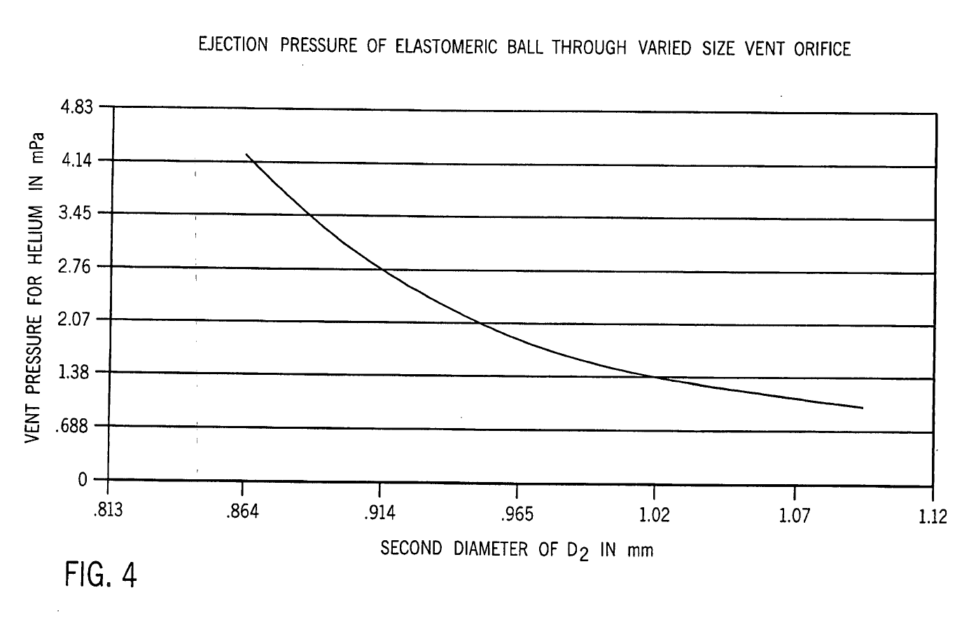

FIG. 4 illustrates the pressure of helium required to force the venting member 73 into the void 104 as a function of second diameter D2 which, in accordance with certain aspects of the invention, can range between 0.813 mm and 1.12 mm. It should be appreciated that the diameter of the venting member 73 relative to the diameter D2 is also partially dependent on the material of the venting member 73 and the eyelet 50, and the invention should not be construed as being limited to the values disclosed herein. It is further recognized that while hydrogen is produced inside a working cell that exerts pressure against venting member 73 during use, helium is a non-explosive gas that is convenient for experimental use.

The present invention provides enhanced design flexibility to reliably and predictably determine the internal cell pressure required to begin venting the cell 20, and furthermore allows flexibility in choice of materials. While the venting member 73 is flexible and can comprise a compliant rubber or deformable plastic (such as polyethylene or Teflon), the venting member 73 can alternatively be formed from a stiff material such as extrudable steel, in which case the eyelet 50 would be made of a flexible conductive material that would deform as the venting member is biased into the void 104 under the forces of internal cell pressure.

The overall design flexibility allows the venting assembly 111 to be integrated with the switch 81, such that the pressure dissipation assembly 106 can be installed as a single assembly. Furthermore, because the switch 81 and the venting assembly 111 are substantially radially aligned in a terminal end of an electrochemical cell, the void 104 is reduced compared to conventional cells having separate venting and pressure dissipation assemblies, and the cell 20 thus provides an increased volume for active electrochemical material. In particular, it has been empirically determined for a size AA cell that the pressure dissipation assembly 106 occupies a cell volume percentage within a range defined at its lower end by 4% and defined at its upper end by 8% or, alternatively 5%. In accordance with a narrow aspect of the invention, the pressure dissipation assembly 106 occupies 4.2% of the cell volume. The cell volume not occupied by the pressure dissipation assembly 106 can be occupied by active electrochemical cell components. It should be appreciated, however, that the present invention contemplates that a pressure dissipation assembly can be installed in a cell that includes either pressure dissipation component (i.e., the switch 81 or the venting assembly 111) without the other component.

While a spiral wound NiMH cell was illustrated above in combination with a narrow nubbin 26 used in consumer cells, the present invention is also applicable to NiMH used in other applications, such as battery packs, where a larger nubbin 26 is desired for welding operations.

For instance, referring now to FIG. 6, an electrochemical cell 120 having a larger nubbin 126 for use in a battery pack is illustrated having reference numerals corresponding to like elements of FIGS. 1-3 incremented by 100 for the purposes of clarity and convenience. The alkaline cell can be primary or secondary and the components of the pressure dissipation assembly 206 illustrated in FIG. 6 are similar to the pressure dissipation assembly 106 illustrated in FIG. 1.

One structural difference between the cell 120 illustrated in FIG. 6 and the cell 20 illustrated in FIG. 1 resides in the positive terminal end cap 124. Specifically, a depressed annular horizontal flange 130 extends radially outwardly from the nubbin 126. The channel 203 extends through the end cap 124 at the interface between the nubbin 126 and the flange 130. The pressure dissipation assembly 206 operates in a manner as described above with reference to pressure dissipation assembly 106 as illustrated and described with reference to FIGS. 1-3.

In view of the above, it will be seen that the several advantages of the invention are achieved and other advantageous results attained. As various changes could be made in the above processes and composites without departing from the scope of the invention, it is intended that all matter contained in the above description and shown in the accompanying drawings shall be interpreted as illustrative and not in a limiting sense.

1. A pressure dissipation system configured for installation in an electrochemical cell containing active electrochemical cell contents, the pressure dissipation system comprising:
a switch controlling electrical communication between a terminal end of the cell and a cell electrode;
a vent that provides a venting channel for pressurized electrochemical cell contents when a predetermined venting pressure acts against a venting member disposed in the vent.

2. The pressure dissipation system as recited in claim 1, wherein the switch responds to a switching pressure in the cell that causes an electrical path to open between the terminal end and the electrode.

3. The pressure dissipation system as recited in claim 2, wherein the switch opens the electrical path in response to a pressure less than the venting pressure.

4. The pressure dissipation system as recited in claim 2, wherein the switch further comprises a first contact in electrical communication with terminal cap and a second contact in electrical communication with the electrode, and wherein the first and second contact separate in response to the switching pressure.

5. The pressure dissipation system as recited in claim 1, wherein the switching pressure is within the range of 344 kPa and 4.14 mPa.

6. The pressure dissipation system as recited in claim 1, wherein the venting member is disposed in an eyelet having a first zone defined by a first diameter and a stepped zone defined by a second diameter less than the first diameter.

7. The pressure dissipation system as recited in claim 6, wherein the venting member is substantially spherical having a diameter sized between the first and second diameters of the eyelet.

8. The pressure dissipation system as recited in claim 7, wherein the venting member is compressed when inserted into the eyelet and the diameter is substantially equal to the first diameter when the venting member is compressed.

9. The pressure dissipation system as recited in claim 6, further comprising a retainer member engaging the venting member to strengthen a seal formed by the venting member.

10. The pressure dissipation system as recited in claim 9, wherein the venting member is disposed between the retainer member and the stepped zone of the eyelet.

11. The pressure dissipation system as recited in claim 1, wherein the venting member is disposed in the stepped zone prior to an occurrence of the venting pressure.

12. The pressure dissipation system as recited in claim 1, wherein the venting member is biased through the stepped zone in response to the venting pressure.

13. The pressure dissipation system as recited in claim 1, wherein the eyelet is substantially centrally disposed in the electrochemical cell.

14. The pressure dissipation system as recited in claim 1, wherein the venting pressure is within the range of 688 kPa and 13.79 mPa.

15. The pressure dissipation system as recited in claim 1, wherein the venting pressure is at least 344 kPa greater than the predetermined pressure required to open the switch and sever the electrical communication between the terminal and the cell electrode.

16. The pressure dissipation system as recited in claim 1, wherein the venting member defines a shape selected from the group consisting of a sphere, an ovoid, and a cylinder.

17. The pressure dissipation system as recited in claim 1, wherein the venting pressure is a positive pressure.

18. The pressure dissipation system as recited in claim 1, wherein the venting member has a hardness substantially within the range of 35 and 90 IRHD.

19. A vent mechanism configured for installation in an electrochemical cell, the vent mechanism comprising:
a housing defining a bore having a first zone defined by a first diameter and a stepped zone defined by a second diameter, the second diameter being less than the first diameter;
a venting member disposed in the bore, wherein a predetermined pressure acts against the venting member to force the venting member out of the bore and provide a venting channel through the housing.

20. The vent mechanism as recited in claim 19, wherein the venting member is aligned with the stepped zone.

21. The vent mechanism as recited in claim 19, wherein the venting member is biased through the first zone and the stepped zone in response to an occurrence of the predetermined pressure.

22. The vent mechanism as recited in claim 19, wherein the predetermined pressure is greater than a pressure required to sever electrical communication between cell electrodes.

23. The vent mechanism as recited in claim 19, wherein the housing is substantially centrally disposed in the electrochemical cell.

24. The vent mechanism as recited in claim 23, wherein the housing comprises an eyelet.

25. The vent mechanism as recited in claim 19, wherein the predetermined pressure is within the range of 688 kPa and 13.79 mPa.

26. The pressure dissipation system as recited in claim 19, wherein the venting member is substantially spherical having a diameter sized greater than the first diameter.

27. The pressure dissipation system as recited in claim 26, wherein the venting member has an uncompressed diameter within the range of 10% and 50% greater than the first diameter of the eyelet.

28. The pressure dissipation system as recited in claim 26, wherein the venting member is compressed when inserted into the eyelet and the dimension is substantially equal to the second diameter when compressed.

29. The pressure dissipation system as recited in claim 19, wherein the venting member defines a shape selected from the group consisting of a sphere, an ovoid, and a cylinder.

30. The vent mechanism as recited in claim 19, wherein the predetermined pressure is a positive pressure.

31 The vent mechanism as recited in claim 19, further comprising a retainer member engaging the venting member to improve a seal formed by the venting member.

32. The vent mechanism as recited in claim 31, wherein the venting member is disposed between the retainer member and the first zone of the housing.

33. The vent mechanism as recited in claim 19, wherein the venting member has a hardness substantially within the range of 40 and 80 IRHD.

34. An electrochemical cell comprising:
a cell terminal disposed proximal a cell terminal end;
an electrode in electrical communication with the cell terminal; and
a pressure dissipation system including:
a switch controlling electrical communication between the terminal end and a cell electrode; and
a venting member that provides a venting channel when a predetermined venting pressure acts against the venting member.

35. The electrochemical cell as recited in claim 34, wherein the switch responds to a switching pressure in the cell that causes an electrical path to open between the terminal end and the electrode.

36. The electrochemical cell as recited in claim 35, wherein the switch opens the electrical path in response to a pressure less than the venting pressure.

37. The electrochemical cell as recited in claim 35, wherein the switch further comprises a first contact in electrical communication with the terminal and a second contact in electrical communication with the electrode, and wherein the first and second contact separate in response to the switching pressure.

38. The electrochemical cell as recited in claim 37, wherein one of the contacts is supported by a flexible grommet member that displaces the supported contact in response to the switching pressure.

39. The electrochemical cell as recited in claim 35, wherein the switching pressure is within the range of 344 kPa and 4.14 mPa.

40. The electrochemical cell as recited in claim 34, wherein the venting member is disposed in an eyelet having a first zone defined by a first diameter and a stepped zone defined by a second diameter less than the first diameter.

41. The electrochemical cell as recited in claim 40, wherein the eyelet is supported by a grommet member that seals the cell terminal end.

42. The electrochemical cell as recited in claim 40, wherein the venting member is aligned with the stepped zone.

43. The electrochemical cell as recited in claim 42, wherein the venting member is biased through the stepped zone and out of the eyelet in response to the venting pressure.

44. The electrochemical cell as recited in claim 43, wherein the venting pressure is determined at least in part by the second diameter.

45. The electrochemical cell as recited in claim 40, wherein the eyelet is substantially centrally disposed in the electrochemical cell.

46. The electrochemical cell as recited in claim 40, wherein the venting member is substantially spherical having a diameter sized greater than the first diameter.

47. The pressure dissipation system as recited in claim 46, wherein the venting member has an uncompressed diameter within the range of 10% and 50% greater than the first diameter of the eyelet.

48. The electrochemical cell as recited in claim 46, wherein the sphere is compressed when inserted into the eyelet and the diameter of the compressed sphere is substantially equal to the first diameter.

49. The pressure dissipation system as recited in claim 40, wherein the venting member defines a shape selected from the group consisting of a sphere, an ovoid, and a cylinder.

50. The electrochemical cell as recited in claim 40, further comprising a retainer member engaging a lower end of the venting member to provide a seal around the venting member.

51. The electrochemical cell as recited in claim 50, wherein the venting member is disposed between the retainer member and the first zone of the eyelet.

52. The electrochemical cell as recited in claim 34, wherein the venting pressure is within the range of 688 kPa and 13.79 mPa.

53. The pressure dissipation system as recited in claim 35, wherein the venting pressure is at least 344 kPa greater than the switching pressure.

54. The electrochemical cell as recited in claim 34, wherein the venting pressure is a positive pressure.

55. The electrochemical cell as recited in claim 34, wherein the venting member has a hardness substantially within the range of 40 and 80 IRHD.

56. The electrochemical cell as recited in claim 35, further comprising a crimped outer container that retains the electrode and the pressure dissipation system, wherein the outer container decrimps at a decrimping pressure.

57. The electrochemical cell as recited in claim 56, wherein the venting pressure is less than the decrimping pressure.

58. The electrochemical cell as recited in claim 57, wherein the venting pressure is within the range of 3% and 85% of the decrimping pressure.

59. The electrochemical cell as recited in claim 57, wherein the switching pressure is within the range of 2% and 40% of the decrimping pressure.

60. The electrochemical cell as recited in claim 57, wherein the decrimping pressure is within the range of 2.75 mPa and 17.93 mPa.

61. The electrochemical cell as recited in claim 60, wherein the venting pressure is within the range of 688 kPa and 13.79 mPa.

62. The electrochemical cell as recited in claim 60, wherein the switching pressure is within the range of 344 kPa and 4.14 mPa.

63. A method for venting pressure in response to an increase in internal pressure of an electrochemical cell of the type including an electrode, a cell terminal, a switch removably connecting the electrode and the cell terminal, and a venting member enabling cell pressure to dissipate, the method comprising:
(A) opening the switch to remove the electrical connection between the electrode and the cell terminal;
(B) experiencing an increase in cell pressure to a venting pressure threshold; and thereafter; and
(C) actuating the venting member to provide a passageway enabling the increased cell pressure to dissipate.

64. The method as recited in claim 63, wherein the venting pressure threshold is greater than the switching pressure threshold.

65. The method as recited in claim 64, wherein the switch comprises a first and second electrical contact, and wherein step (A) comprises biasing one of the contacts out of communication with the other contact.

66. The method as recited in claim 65, wherein the biased contact is movably supported by a grommet that seals a cell terminal end and step (A) further comprises biasing the grommet to open the switch.

67. The method as recited in claim 64, wherein the venting member is disposed in an eyelet having a first zone defined by a first diameter and a stepped zone defined by a second diameter less than the first diameter.

68. The method as recited in claim 67, wherein step (C) further comprises passing the venting member through the stepped zone and out the eyelet.

69. The method as recited in claim 68, wherein step (C) further comprises passing the increased cell pressure through the eyelet.

70. The method as recited in claim 67, further comprising the step of engaging one end of the venting member with a retainer to compress the venting member against the stepped zone of the eyelet.

71. The method as recited in claim 63, wherein step (A) further comprises opening the switch when the cell pressure is within the range of 344 kPa and 4.14 mPa.

72. The method as recited in claim 63, wherein step (C) further comprises actuating the vent when the cell pressure is within the range of 688 kPa and 13.79 mPa.
